(19) United States
(12) Patent Application Publication
(10) Pub. No.: US 2017/0206454 A1
(43) Pub. Date: Jul. 20, 2017

(54) METHOD AND SYSTEM FOR PROVIDING TYPE INFORMATION AND EVALUATION INFORMATION, USING DATA COLLECTED FROM USER TERMINAL

(71) Applicant: UNIVERSITY-INDUSTRY COOPERATION GROUP OF KYUNG HEE UNIVERSITY, Yongin-si, Gyeonggi-do (KR)

(72) Inventor: Chang Ho JIHN, Seongnam-si (KR)

(73) Assignee: UNIVERSITY-INDUSTRY COOPERATION GROUP OF KYUNG HEE UNIVERSITY, Yongin-si, Gyeonggi-do (KR)

(21) Appl. No.: 15/322,236

(22) PCT Filed: Jun. 23, 2015
(86) PCT No.: PCT/KR2015/006366

§ 371 Date: Apr. 3, 2017

(30) Foreign Application Priority Data
Jun. 24, 2014 (KR) 10-2014-0077612
Jun. 17, 2015 (KR) 10-2015-0086066

(51) Int. Cl. G06N 5/04; H04W 4/02

(52) U.S. Cl. CPC G06N 5/04; H04W 4/021; H04W 4/027; H04W 84/18

(57) ABSTRACT

Disclosed is a method and system for providing type information and evaluation information, using data collected from a user terminal. A method for providing type information and evaluation information may comprise the steps of: storing and maintaining an evaluation item for an individual; identifying collection data—the collection data includes a location of the evaluation target person and time record data—collected from at least one of a terminal of a person to be evaluated and a reader device installed at a predetermined place; and generating at least one of type information and evaluation information for the individual on the basis of predetermined correlation between the evaluation item and the collection data.

### TECHNICAL FIELD

At least one example embodiment relates to a method and system for providing type information and evaluation information using data collected from terminal, for example, a method and system for inferring a type of a personal life based on any type of information collectable from a terminal of an individual, and providing evaluation information about the individual.

Here, the data collected from terminal may include a variety of data collectable from a terminal of an individual, such as location data, venue/regional information, temporal data, event schedule information, sensor data, communication data, demographic data, etc.

### RELATED ART

Technology using a location-based service or location information according to the related art collects location information of a terminal and predicts a dangerous situation or provides a customized service to the user.

For example, a home network system, a ubiquitous computing system, or a telematics service provides a service generally based on location information of a user.

Cited Reference 1, Japanese Patent Publication No. 2013-101449, relates to an “apparatus for estimating a lifestyle of a user using a portable terminal”. Cited Reference 1 discloses technology for further clearly estimating location and temporal information of a user by periodically collecting location information of a portable terminal from a base station and by correcting the periodically collected location information.

Cited Reference 2, Korean Patent Registration No. 10-0994151, relates to a “service providing system optimized for a lifestyle of a user in a ubiquitous computing environment”. Cited Reference 2 discloses technology for verifying location information of a user using a sensor and the like in a ubiquitous computing environment provided in a living space of the user, and transmitting verified temporal information and sensor information to the user to estimate a preference and a lifestyle of the user.

Cited Reference 3, Korean Patent Publication No. 10-2008-0092645, relates to a “method and apparatus for providing human relationship information by analyzing log data of a personal communication terminal”. Cited Reference 3 discloses an example of analyzing log data associated with a terminal use history of an individual through a personal communication terminal.

The related arts disclose a variety of services or inference methods using location information. However, location information is simply used to infer a lifestyle or a preference of an individual.

### DETAILED DESCRIPTION

### Technical Subjects

At least one example embodiment provides a method and system for evaluating a personal life based on any type of data collectable from a terminal, the data including location data, venue/regional information, temporal data, event schedule information, sensor data, communication data, and demographic data.

Also, at least one example embodiment provides a method and system that may provide type or evaluation information about a personal life or lifestyle so that a company may implement a substantial personality or life evaluation on a job candidate.

### Solutions

According to an aspect of at least one example embodiment, there is provided a method of providing type information and evaluation information, the method including storing and maintaining an evaluation item about an individual; verifying data collected from at least one of a terminal of an evaluation target and a reader device installed at a predetermined place, the collected data including location and timestamp data of the evaluation target; and creating at least one of type information and information for evaluating the target of the individual based on a predetermined correlation between the evaluation item and the collection data.

According to another aspect of at least one example embodiment, there is provided an apparatus for providing type information and evaluation information, the apparatus including an evaluation item manager configured to store and maintain an evaluation item about an individual; a collected data analyzer configured to analyze data collected from at least one of a terminal of an evaluation target and a reader device installed at a predetermined place, the collected data including location and timestamp data of the evaluation target; and an evaluation information creator configured to create at least one of type information and for evaluating the target based on a predetermined correlation between the evaluation item and the collection data.

### Effects

According to example embodiments, there may be provided a model that may evaluate a personal life based on any type of data collectable from a terminal, the data including location data, venue/regional information, temporal data, event schedule information, sensor data, communication data, and demographic data.

Also, according to example embodiments, there is provided a method and system that may provide type or evaluation information about a personal life so that a company may implement a substantial personality or life evaluation on a job candidate.

Also, according to example embodiments, there may be provided a model that may perform a quality-centered organization evaluation based on an individual evaluation of an organization member, instead of performing an organization evaluation based on an externally expressed organization outcome.

Also, according to example embodiments, evaluation information used as a supplementary material for evaluation may be created by, without restrictions on a time and a space, continuously monitoring a personality aspect of an individual, which may not be readily learned through a one-time evaluation tool or interview.

### BRIEF DESCRIPTION OF DRAWINGS

FIG. 1 is a diagram illustrating a concept of a type information and evaluation information providing system according to an example embodiment;

FIG. 2A is a block diagram illustrating an example of a configuration of a type information and evaluation information providing apparatus according to an example embodiment;

FIG. 2B is a block diagram illustrating an example of a configuration of a collected data analyzing apparatus according to an example embodiment;

FIG. 3 is a flowchart illustrating a type information and evaluation information providing method according to an example embodiment; and

FIG. 4 is a flowchart illustrating a type information and evaluation information providing method according to another example embodiment.

### BEST MODE

Hereinafter, example embodiments will be described with reference to the accompanying drawings.

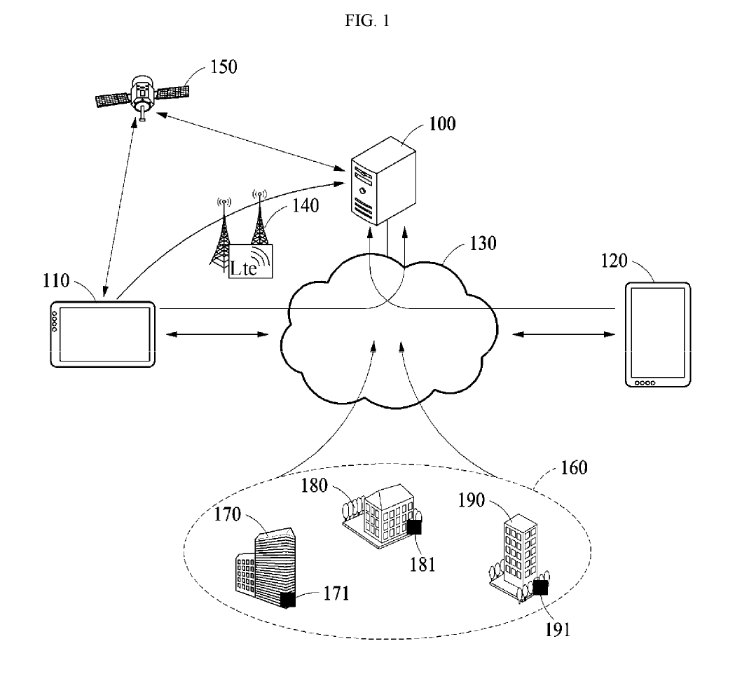

FIG. 1 is a diagram illustrating a concept of a type information and evaluation information providing system according to an example embodiment.

Referring to FIG. 1, the type information and evaluation information providing system includes user terminals 110 and 120, a server 100, and reader devices 171, 181, and 191 installed at buildings or specific places of a predetermined institution.

The user terminals 110 and 120, the server 100, and the reader devices 171, 181, and 191 may access networks 130 and 140 for communication. Here, a communication network 130 may include a cloud computing environment, the wireless Internet, and a near field communication (NFC) network, and may also include a mobile communication network, such as a long term evolution (LTE) network 140.

Each of the user terminals 110 and 120 may receive location information based on a signal from a global positioning system (GPS) 150, and may store the location information and transmit the location information to the server 100. Also, location information of each of the user terminals 110 and 120 collected through a mobile communication base station or a wireless access point (WAP) may be collected and stored at the server 100 periodically or at predetermined intervals.

Each of the user terminals 110 and 120 may include a configuration for sensing a biometric signal, data required for recognizing a situation, etc., which is applied to a current smart terminal, in addition to a communication function.

Each of the reader devices 171, 181, and 191 may be a computer terminal that stores an access record for each of a WAP, a radio frequency identification (RFID) reader, an NFC reader, or an identifier of an evaluation target.

For example, the predetermined institution may be a university campus 160.

Here, the university campus 160 may include specific places, for example, an entrance gate 170, a library 180, and a lecture room 190.

As another example, reference numeral 160 may refer to a place having a specific purpose, such as an institutes street, an adult entertainment district, welfare facilities, a national park, etc.

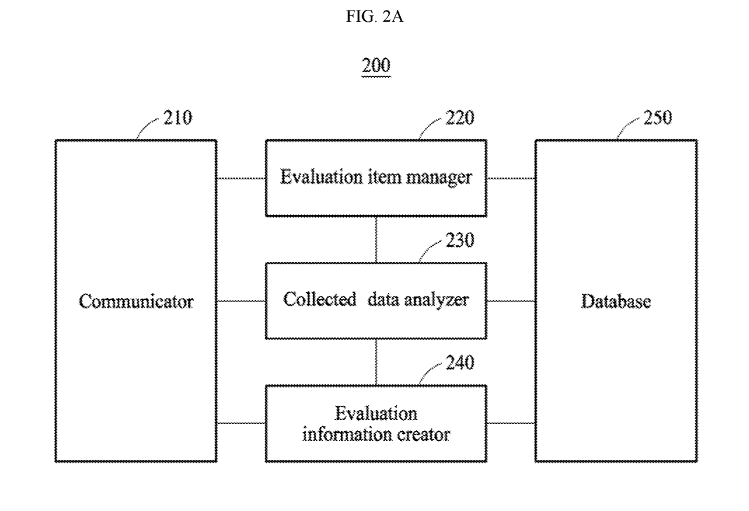

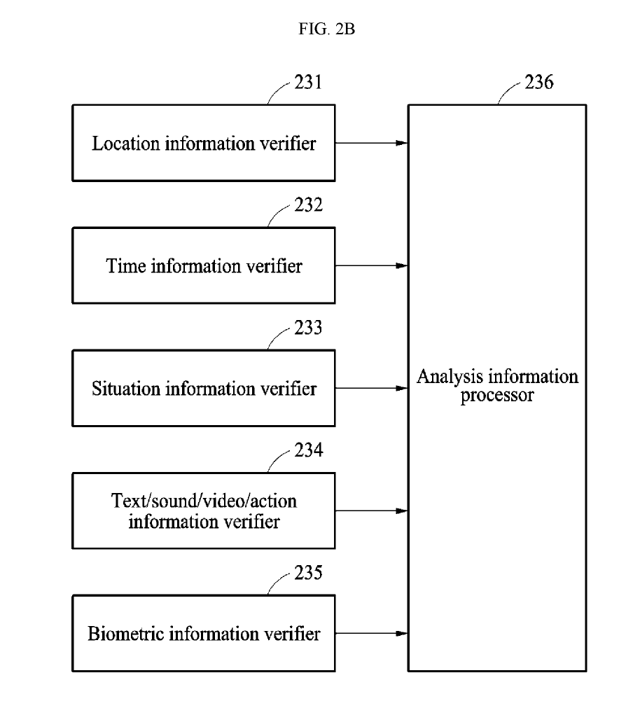

FIG. 2A is a block diagram illustrating an example of a configuration of a type information and evaluation information providing apparatus according to an example embodiment.

A type information and evaluation information providing apparatus 200 of FIG. 2 may be provided to each of the server 100 and the user terminals 110 and 120 of FIG. 1.

If the type information and evaluation information providing apparatus 200 is provided to a user terminal, information for evaluation (also, referred to as evaluation information) may be created at the user terminal and transmitted to a server.

Referring to FIG. 2A, the type information and evaluation information providing apparatus 200 includes an evaluation item manager 220, a collection data analyzer 230, and an evaluation information creator 240.

Also, the type information and evaluation information providing apparatus 200 may further include a communicator 210 configured to collect data and to transmit and receive data over a communication network, and a database 250 configured to store the collection data and created data.

The evaluation item manager 220 stores and maintains an evaluation item about an individual.

The collection data analyzer 230 analyzes data collected from at least one of a terminal of an evaluation target and a reader device installed at a predetermined place, and verifies the analyzed data.

The collected data includes location and timestamp data of the collection target, venue/regional information, event schedule information, sensor data, communication data, and demographic data.

The collection data analyzer 230 collects and stores at least one of location data that includes a tracking information about a location and a movement of the evaluation target, temporal data associated with the location data, regional or venue information estimated from the location data, sensor data and event schedule information used for recognizing a situation in association with the location data or the temporal data, communication data about communications transmitted to and received from another terminal or a server, and demographic data.

Here, the evaluation target may be an individual that has joined a service provided from the apparatus 200, and has agreed on collection of data associated with the evaluation target. Accordingly, the individual having joined the service may be assigned with a unique identifier from the apparatus 200, and may be used to identify data collected at a reader device and the like.

The evaluation information creator 240 creates at least one of type information of individual (also, referred to as type information) and evaluation information about the individual based on a predetermined correlation between the evaluation item and the collected data.

The evaluation information creator 240 may create evaluation information based on at least one of a correlation between the evaluation item and a place to stay of the evaluation target inferred from location data of the evaluation target, a correlation between the evaluation item and a dwell time at the place to stay, a correlation between the evaluation item and places to which the evaluation target moved, a correlation between the evaluation item and a situation of the evaluation target estimated based on sensor data and event schedule information associated with the evaluation target, the place to stay, and the dwell time, and a correlation between the evaluation item and data transmitted to and received from another terminal or a server present around the terminal.

For example, if the evaluation item is set as sincerity of school life or diligence of an individual, the evaluation information creator 240 may create evaluation scores by quantifying a number of times the evaluation target has stayed at a place, for example, a library, a visit interval, and a number of times the evaluation target has visited the library at a time excluding an examination period.

The evaluation information creator 240 may create evaluation information based on a correlation between the evaluation item and a dwell time of the evaluation target at a specific place.

For example, information about a dwell time at a place “gymnasium” with respect to a student A who majors in a physical education may be used in association with an evaluation item “diligence or sincerity”. Here, a different evaluation criterion may be applied even to the same place, based on the evaluation item and personal information of the evaluation target in association with the specific place or space.

In an example in which the evaluation item is “sincerity or diligence” and the specific place is “gymnasium”, high scores may not be assigned to an office worker B in association with “sincerity or diligence” and high scores may be assigned to the student A who majors in the physical education in association with “diligence or sincerity”, regarding the dwell time at the place “gymnasium” during a daytime of a weekday.

Also, a different evaluation criterion may be applied even to the same place based on the evaluation item and situation information of the evaluation target, in association with the specific place or place.

In an example in which the evaluation item is “teamwork” or “sociality” and the specific place is a café around a school, if a university student C is determined to be under an event schedule that a team assignment is to be submitted within three days and to be discussing content associated with the team assignment at a café with other students who take a corresponding lecture, an affirmative evaluation may be assigned to the student C in association with “teamwork” or “sociality”. An event schedule may be verified by referring to an assignment schedule, etc., open to an online learning system, and whether students taking the corresponding class are present at the same place may be verified. Further, mutual proximity may be measured through Bluetooth sensors provided in terminals of a portion of students that are determined to be present at the same place. If the students are present within a certain distance, the students may be estimated to be present at the same place in order to meet with each other. Further, the accuracy of evaluation may be enhanced by analyzing peripheral sound data acquired through a microphone sensor of a terminal and by determining a correlation between conversation content and a class.

The evaluation information creator 240 may create evaluation information based on a correlation between the evaluation item and places to which the evaluation target has moved.

The evaluation information creator 240 may create evaluation information based on a correlation between an evaluation criterion and a point in time at which the evaluation target enters and leaves a specific space.

For example, with respect to a student B who majors in a physical education, evaluation information, for example, diligence or sincerity, may be created based on how long the student B has stayed at a place “gymnasium” based on a point in time at which the student B has entered and left the place “gymnasium”, how regularly the student B has used the place, and whether the student B has observed an entrance time and a leave time according to a related event schedule.

Likewise, the evaluation information creator 240 may create evaluation information based on at least one of scores of diligence, sincerity, teamwork, discipline, service spirit, challenge spirit, progressive spirit, autonomy, and self-management that are evaluated based on at least one of location information, temporal information, venue and regional information, situation information, text/sound/video/action information, and biometric information extracted from the collected data.

FIG. 2B is a block diagram illustrating an example of a configuration of a collection data analyzing apparatus according to an example embodiment.

The collection data analyzing apparatus of FIG. 2B may be a detail configuration of the collection data analyzer 230 of FIG. 2A.

Referring to FIG. 2B, the collection data analyzing apparatus may include a location information verifier 231, a time information verifier 232, a situation information verifier 233, a text/sound/video/action information verifier 234, a biometric information verifier 235, and an analysis information processor 236.

The location information verifier 231, the time information verifier 232, the situation information verifier 233, the text/sound/video/action information verifier 234, the biometric information verifier 235, and the analysis information processor 236 may be configured as at least one processor to perform the respective functions.

The location information verifier 231 may include location information recorded in a terminal, information associated with a venue/regional, and information associated with a place extractable from collected data, such as information collected from a reader device installed in a building.

The time information verifier 232 may collect temporal information from the collected data. For example, the temporal information may include information associated with a timestamp extractable from the collection data, such as a point in time at which the terminal enters at a specific location, a temporal history in which the user has used a specific application, a time at which the terminal has used communication data, and the like.

The situation information verifier 233 may extract situation information associated with the evaluation target at a specific point in time and a specific place from the collected data.

The situation information verifier 233 extracts situation information from data that is collected via a variety of sensors. For example, the situation information verifier 233 may extract collective situation information by combining stay place information, temporal information, event schedule information of the evaluation target information with peripheral situation information corresponding to a specific point in time to recognize a situation in which the target evaluation encounters at the specific point in time. For example, if a university student C corresponding to the evaluation target has stayed at a café around a university from 1 p.m. to 3 p.m. on Jul. 1, 2015, and gathered with other students taking a specific lecture together during the stay, and most of conversations between the students were about the lecture or a team assignment, and a schedule as saying that the team assignment of the lecture should be submitted by Jul. 4, 2015, was disclosed on an assignment schedule of an online lecture system, the situation may be estimated that the evaluation target had to stay at the café to discuss carryout of the team assignment with the students at that time.

The text/sound/video/action information verifier 234 may extract text, sound, video, action information, etc., from the collected data. For example, the text/sound/video/action information verifier 234 may extract a specific word, sentence, etc., associated with an evaluation item from text data, such as extracting a product name or a store name associated with a purchase action from a credit card payment text message. Also, the text/sound/video/action information verifier 234 may extract action information of the evaluation target from a site access history included in communication data, an app use history, or SNS data.

The biometric data verifier 235 may verify whether biometric data is present in the collected data, and may classify the biometric data for each type or verify a pattern of biometric data and the like. For example, the biometric data may include a brainwave and an electrocardiogram (ECG) signal.

The analysis information processor 236 may process information extracted from at least one of the location information verifier 231, the time information verifier 232, the situation information verifier 233, the text/sound/video/action information verifier 234, and the biometric information verifier 235 to be information suitable for the evaluation item.

For example, if the evaluation item is “diligence or sincerity”, the analysis information processor 236 may sort location information extracted from the location information verifier 231 in order of times extracted from the time information verifier 232, and may verify a dwell time at a specific location, a number of visits at the specific location, visit date and temporal information associated with a specific place, and the like, and may provide the verified information to the evaluation information creator 240.

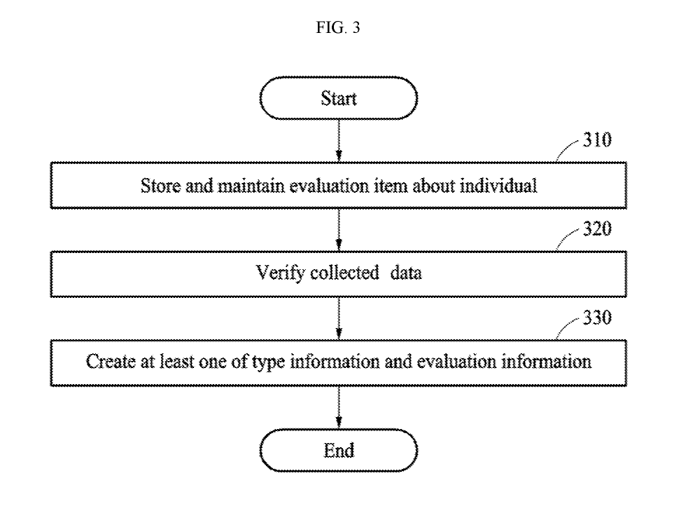

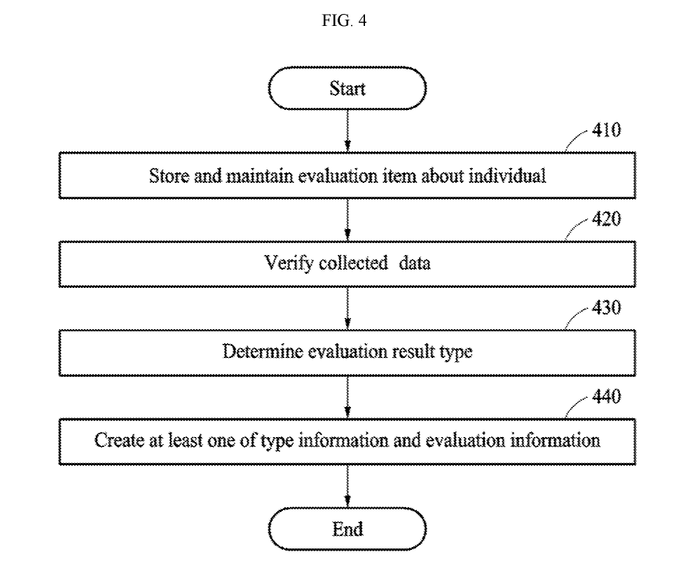

Hereinafter, example embodiments of a type information and evaluation information providing method that may be performed at the type information and evaluation information providing apparatus 200 will be described with reference to FIGS. 3 and 4.

FIG. 3 is a flowchart illustrating a type information and evaluation information providing method according to an example embodiment.

Referring to FIG. 3, in operation 310, a type information and evaluation information providing apparatus stores and maintains an evaluation item about an individual.

The evaluation item about the individual may include an item for evaluating a personal life. Also, the evaluation item may include an item for evaluating a group that includes the individual. Also, the evaluation item may include an item associated with inference of a personal lifestyle.

As described above, the evaluation item about the individual may be associated with a personality that is regarded to be an important factor for interviewing a job interviewee at a company.

The item for evaluating the personal life may include, for example, diligence, sincerity, teamwork, discipline, service spirit, progressive spirit, responsibility, activity, autonomy, self-directedness, leadership, self-management, reliability, consistency, optimism, probity, psychological stability, challenge spirit, consideration, generosity, flexibility, adaptability, insight, intuition, horizontal relationship, and the like.

For example, data used to evaluate an item associated with the self-management may include information collected from a healthcare system associated with a physical strength.

An evaluation about the psychological stability may use brainwave data measured from brainwaves of the individual, or may be determined based on whether a word or a sentence associated with the psychological stability is included in text data received from the individual. Here, a relationship between the evaluation item and collected data for evaluation may be set using a variety of schemes based on a configured system type.

In operation 320, the type information and evaluation information providing apparatus verifies data collected from a terminal of the evaluation target and a reader device installed at a predetermined place.

The collected data includes location and timestamp data of the evaluation target, timestamp data, venue/regional information, sensor data, event schedule information, communication data, and demographic data.

The collected data may be data directly received from a user terminal, primarily analyzed data, such as place data that is created by extract matching venue information from collected location data, data received from reader devices installed at predetermined places.

A type of collected data may include location data that includes a tracking information about a location and a movement of the evaluation target, temporal data associated with the location data, and regional or venue information estimated from the location data. Also, the collected data may further include at least one of sensor data and event schedule information used for recognizing a situation associated with the location data and the temporal data, and communication data about communications transmitted to and received from another terminal or a server.

Hereinafter, examples of data (, which is also referred to as collected data,) collected and used to evaluate a personal life will be described. Here, data collected and used to evaluate the personal life may be analyzed at a specific point in time. Also, a relationship between a plurality of pieces of data acquired at plural time points may be applicable for analysis based on a sequential change over time. The sensor data may be collected through an acceleration sensor of a terminal, a gyroscope sensor, an optical sensor, a temperature sensor, a barometer sensor, a microphone sensor, a Bluetooth sensor, a heart rate sensor, etc. Situation information, such as a motion or movement situation of the evaluation target, etc., may be extracted from data collected from the acceleration sensor or the gyroscope sensor. Situation information about an ambient environment of the evaluation target may be extracted from data collected from the temperature sensor or the barometer sensor. Situation information, such as a person having a conversation with the evaluation target and conversations exchanged therebetween may be extracted through the microphone sensor and the Bluetooth sensor. Biometric information of the evaluation target may be extracted through the heart rate sensor.

The communication sensor may include a call frequency with a specific person or a total call frequency, a call use period, a call time zone, etc., and may also include recorded call content under the agreement.

Also, the communication data may also include a search log, cookie information, a text message, an audio file, a video file or a tag, communication counter party information, use protocol information, and the like.

The search log may be collected at an application or an OS installed on the terminal. For example, the search log may be an Internet surfing URL and search keyword data.

The communication data may include text data, image, video, etc., uploaded to or exchanged through an SNS account of an individual. Such materials exchanged with another person may be used as complex evaluation materials, such as evaluation of a counter party, an action, and the like, associated with personality of the individual.

The collected data may include demographic data. For example, the demographic data may include a variety of data, such as the individual's gender, age, marital status, information about family members, current job or desired job, current income or desired income, and the like.

In general, if venue information is a “region A outside a school”, and a dwell time and an access frequency of a student corresponding to an evaluation target at the region A are greater than those at the school, relatively poor evaluation information may be provided in association with sincerity. However, if the evaluation target is a student of an art, music, and physical education related school and the region A is an institution, a gym, or a studio required for the student to prepare for the future, relatively high evaluation scores may be assigned in association with sincerity or readiness. Accordingly, the evaluation information providing system may evaluate the personal life by combining a variety of information. The collected data may be collected from wearable devices, such as currently commercialized smart glasses, smart watch, etc. For example, the collected data may include gaze shift data of a user gazing a text and an image, and may include a point, a gaze time, a gaze frequency, etc., when the user views a photo. Data collected from the wearable devices may be acquired from a special environment or a controlled user. Thus, the system may determine the reliability of the collected data or whether to use the collected data, based on a route, a device, etc., used to collect the data.

Basically, the collected data includes location data.

The location data may be latitude or longitude data of a GPS, or may be location information verified from a base station or a wireless access point. Also, in the case of a reader device installed at a specific place, location or venue information may be recorded in advance in the system.

The collected data may include regional information or venue information. Here, the regional information or the venue information may be derived at the server from the collected latitude and longitude information. Specific building or brand information, such as map data of a navigation device, may be directly collected.

The collected data may include product or service purchase data from which interest or hobbies, etc., of the individual may be inferred.

For example, purchase data may include a purchased product name, a purchase date and time, a purchase situation, a purchase situation, a purchase frequency, a purchase price, and the like. The purchase data may be used as an evaluation index to verify readiness, challenge sprit, moderation, etc., based on a configuration example of the system.

Referring again to FIG. 3, in operation 330, the type information and evaluation information providing apparatus creates at least one of type information and evaluation information of the individual based on a predetermined correlation between the evaluation item and the collected data.

Depending on an implementation environment, all of the collected data may be associated with the evaluation item and only a portion of the data may be associated with the evaluation item. Also, collected data may be analyzed with respect to all of the evaluation items, and evaluation information may be created only with respect to an evaluation item inferable from the collected data among the entire evaluation items.

The evaluation information creator 240 may create evaluation information based on a correlation between an evaluation item and persons the evaluation target meet. For example, if location information of the persons the evaluation target meets is also collected, the evaluation information creator 240 may verify a nature of meeting, such as whether the meeting is a campus meeting or a meeting associated with an activity or a teamwork, from venue information, and may create evaluation information about the activity or the teamwork based on a meeting frequency or cycle, and the like.

The evaluation information creator 240 may create evaluation information based on a correlation between an evaluation item and persons the evaluation target meets. For example, if the persons the evaluation target meets has also joined a service, location record information and personal identification information are collectable, and a job or career of a person the evaluation target meets has relevance to a company that receives the evaluation information, the evaluation information creator 240 may assign relatively high scores, and may extract a meeting frequency, etc., from location record information of the evaluation target and the meeting person and may also assign scores or grades based on the meeting frequency.

The evaluation information creator 240 may set a correlation between an evaluation item and each type of collected data. Accordingly, if collected data is communication data about communications transmitted to and received from another person, the evaluation information creator 240 may create evaluation information based on a specific evaluation item. Also, the evaluation information creator 240 may create evaluation information by applying a predetermined criterion to collected data about a search and an action through the Internet conducted by the evaluation target. Likewise, the evaluation information creator 240 may create evaluation information based on various types of expression data, for example, text, sound, image, and video, of another person toward the evaluation target. For example, if text data received at the evaluation target includes expressions, such as “You are sincere”, “You make great efforts”, “You are reliable”, etc., the evaluation information creator 240 may assign relatively high scores in association with the evaluation item, reliability or sincerity.

If facial expression data and biometric data of the evaluation target are collected through various types of wearable computing devices, special purpose devices, and the like, the evaluation information creator 240 may use the collected data for an evaluation item. For example, the evaluation information creator 240 may create evaluation information “calm without being greatly excited” based on variation or peak period information of heart rate from heart rate information included in the biometric information.

Here, the evaluation information may be provided to an evaluator using total scores or grades of evaluated items, etc.

Hereinafter, examples of evaluating a personal life of a student based on collected data will be described.

In association with “sincerity or diligence”, in the case of a student, evaluation information may be created based on a dwell time at a library from location information, venue information, and timestamp data.

In detail, scores may be calculated by collecting curriculum information of a corresponding school and completed by the evaluation target and by quantifying lateness frequency, late hour information, etc., from location information and timestamp data. As another example, the evaluation target may be determined to have been present at a place “institutes street” periodically from a record after a school and, in this case, relatively high scores may be set to be assigned in association with “sincerity or diligence”.

If the evaluation target is not a student but a worker, work commitment or attitude, etc., may be added as an evaluation item. In association with work commitment, information, such as use frequency of a specific application, a use time, etc., may be collected from a smart terminal use log record, and relatively high scores may be set to be assigned if the evaluation target has barely used a mobile messenger and the like during working hours.

An evaluation item, such as “teamwork or cooperative spirit”, may be evaluated from data collected in some special situations and controlled environment.

For example, persons who often meet the evaluation target may be verified from terminal location information of the evaluation target and terminal location information of the persons. Also, information of the persons or a number of persons may be verified from access history or terminals connected to a reader device installed at a specific place registered to the system. The specific place may be, for example, a rental meeting room, a campus seminar room, etc.

If a corresponding gathering group is verified, regional information associated with a gathering location may be verified to determine whether it is suitable for a meeting place and to determine whether a time is suitable for a meeting time. Through this, a process of determining whether the meeting may be used as a target to evaluate teamwork may be performed.

For example, in the case of a general meeting for implementing a final example project, an aspect of having the meeting before or after school hours in a campus study room or a study room outside a school and an aspect of having the meeting at a late nighttime in a pub, Karaoke, etc., may be considered. In the case of a worker, if places or persons the worker frequently gathers with outside a company are verified, teamwork scores may be calculated.

If a region definable as an adult entertainment district is set and information about an access time or frequency to the region is collected, a relatively low evaluation may be assigned in association with discipline or living attitude. If accuracy of location information is low, discipline or living attitude may be set to be excluded from evaluation items.

As described above, if location data of the evaluation target, venue information inferred from the location data, timestamp information associated with a location, etc., are collected, service spirit, progressive sprint, self-management or self-enlightenment, reliability, etc., may be evaluated by considering a feature of the corresponding place, a dwell time, and the like.

For example, an evaluation item, such as “challenge spirit” or “passion”, may be evaluated based on how often the evaluation target has appeared at an exposition or the like. Also, activity may be evaluated based on an attendance frequency at a forum or an exposition associated with a major field of the evaluation target. On the contrary, the evaluation item, such as “challenge spirit” or “passion”, may be evaluated based on an appearance frequency at a forum or an exposition unassociated with the major field of the evaluation target.

Table 1 shows an example of “evaluation item”, “evaluation index” according to the evaluation item, “collected data” required for the evaluation index, and a “score calculation method” for evaluation.

In Table 1, evaluation information may be finally created with respect to all of or a portion of the “evaluation items”. “Evaluation index” may be stored in the evaluation item manager 220 of FIG. 2A or may be stored in the analysis information processor 236 of FIG. 2B. “Collected data” may be extracted at the collected data analyzing apparatus of FIG. 2B.

The evaluation information creator 240 may create evaluation information calculated as scores according to the “score calculation method”.

TABLE 1

| | | | Score calculation |
|---|---|---|---|
| Evaluation item | Evaluation index | Required data | method |
| Sincerity | arrival on time | Location data per | ~4 m~+1 mi: 0 point |
| | | time | ~−5: +1 point |
| | | | +2 m~+5 m: −1 point |
| | | | +6~+15: −2 points |
| | | | +16~: −3 points |
| | work commitment | Terminal | Score by deducting |
| | | (smartphone) use | scores for use of |
| | | frequency during | mobile messenger, |
| | | working hours | text, call, Internet, |
| | | | game, etc. |
| Diligence | appropriateness of | location data per | Deduct scores for |
| | stay place | time-location name | visit to place |
| | | | inappropriate for |
| | | | position during |
| | | | working hours |
| | time used to move | daily work timetable | absolute evaluation |
| | between places | location data per | relative evaluation |
| | suitable for diligence | time | |
| | evaluation | | |
| | location movement | | |
| | frequency | | |
| | diversity of self | daily work timetable | absolute evaluation |
| | development | location data per | relative evaluation |
| | | time | |
| Diversity (self | diversity of self | daily work timetable | Whether reference |
| development) | development | location data per | period satisfying |
| | | time | consistency has |
| | | | elapsed (e.g., |
| | | | swimming 1 year, |
| | | | yoga 3 months, etc.) |
| Teamwork | activity | daily work timetable | Whether reference |
| | cooperation | location data per | period satisfying |
| | | time | consistency has |
| | | with another | elapsed (e.g., |
| | | terminal | swimming 1 year, |
| | | | yoga 3 months, etc.) |

In the score calculation method according to Table 1, for example, if venue information is “institution”, a subject the evaluation target is taking is open at the corresponding place on every Wednesday and Thursday, and the evaluation target is verified to have visited the institution on Wednesday and Thursday, the evaluation information creator 240 may determine the corresponding data as information available to evaluate sincerity.

If the user is a worker, the evaluation information creator 240 may evaluate sincerity by applying work commitment as an evaluation index from specific application use frequency data of a terminal during working hours. For example, the application use frequency may be differentiated based on a type and be used to deduct scores of the work commitment. That is, relatively high scores may be deducted in order of a game, the Internet, and a mobile messenger

The evaluation information creator 240 may calculate scores by applying an absolute evaluation scheme or a relative evaluation scheme to an item that may be evaluated based on a predetermined score calculation criterion.

For example, if evaluation information about “sincerity”, “diligence”, and “sociality” may be created from collected data, the evaluation information creator 240 may set perfect scores for each item as 100 and may calculate total scores. Also, the evaluation information creator 240 may assign a predetermined weight to each item and may calculate weighted total scores.

FIG. 4 is a flowchart illustrating a type information and evaluation information providing method according to another example embodiment.

Operations 410, 420, and 430 of FIG. 4 are the same as or correspond to operations 310, 320, and 330 of FIG. 3, respectively.

Referring to FIG. 4, the type information and evaluation information providing apparatus determines an evaluation result type in operation 430, and creates at least one of type information and evaluation information based on the determined type in operation 440.

Here, the evaluation result type may be a type of evaluation information and may include a comment associated with scores or personality of an individual. Also, the evaluation result type may be a result of comparison between the individual and a predetermined role model. Here, the result of comparison may include a proximity level between lifestyle information of the role model and type information of the individual or a type information comparison result at plural time points. For example, lifestyle information of the role model included in the result of comparison may include at least one of health related information and criminal type information.

Single evaluation information about the evaluation target, that is, the individual may be scores calculated based on the evaluation item and the evaluation index. For example, the single evaluation information may be provided as quantitative scores, such as 8.7 out of 10 points in sincerity, and the like, and may be provided in a text format, such as “the evaluation target has an excellent sincerity and challenge spirit, and has steadily conducted volunteer activities”.

For comparative evaluation, a role model that is a reference of the evaluation may be considered. Here, the evaluation information may present a difference or a differential level between the corresponding role model and each evaluation item.

Type of talent, for example, a role model, may be a specific person, and may be defined as a representative personal life aspect of a specific group. For example, a single famous violinist may be selected as the role model and be set as a comparison target. A common personal life aspect of a few famous violinists may be used to define the role model that is a comparison target. A result of evaluating a personal life of the individual or the group selected as the role model may be acquired through a terminal if terminal information of the person or the group is disclosed. However, if the role model is to be selected from among a plurality of unspecific persons, whether a corresponding person is a target desired to be selected may be determined based on data collected from all of terminals to be compared. For example, celebrities may gather at the Blue Dragon Awards. A terminal of a specific person may be identified by verifying location information and temporal information, and the like, in public. Once a holder of the terminal is verified, personal life information may be collected and analyzed.

The comparative evaluation may be performed at a specific point in time. For example, a difference may be calculated for each evaluation item by comparing the evaluation target and the corresponding role model at a single point in time.

The comparative evaluation may be performed using a comparison result at plural time points. For example, a proximity level and the like may be created as evaluation information by acquiring an evaluation result at plural time points with respect to a famous politician, and by comparing an evaluation result that is acquired by evaluating the evaluation target at each point in time corresponding to the plural time points, to the evaluation result associated with the famous politician.

Depending on example embodiments, the system may conduct an evaluation with respect to the plural time points, and may provide prediction information regarding whether the evaluation target may reach a personal life level of the famous politician at a specific point in time of the future, based on an absolute value of a difference, an increase or a decrease, etc., between evaluation results for the respective points in times.

As an application example of the role model, the system may provide a service of creating a sample lifestyle by verifying a lifestyle of a specific community and by, if a similarity between a lifestyle of the evaluation target and the sample lifestyle is high, notifying the evaluation target or a third party of the sample lifestyle.

For example, the system may verify a lifestyle of persons having a specific disease and may determine that the evaluation target is highly likely to catch the disease if the lifestyle of the evaluation target is closer to the verified lifestyle.

Meanwhile, although FIGS. 3 and 4 are described based on the personal life evaluation, evaluation information may be created based on an institution, an organization, or a group.

For example, evaluation information about a group of the evaluation target may be created by grouping evaluation information based on the group and by collecting evaluation information of other evaluation targets that are included in the group.

Here, evaluation information may be an comparison result compared in a form of a contention or a battle between groups. Here, the comparison result may be a simple distribution of scores, however, may include information about an activity radius or a lifestyle of an individual having relatively high scores in a specific evaluation item.

Based on evaluation information about a group, a student-centered university evaluation criterion based on efforts and capabilities of students, not capabilities of a university, may be provided. Further, the provided information may be used as materials to evaluate the internal stability of each university by evaluating each university based on students, not university institution itself.

For example, a plan for improving a participation into study may be presented to students of a university showing a poor participation into study by analyzing a university showing an excellent participation into a study and a lifestyle feature of an individual.

The apparatuses described herein may be implemented using hardware components, software components, and/or combination of the hardware components and the software components. For example, the apparatuses and the components may be configured using at least one universal computer or special purpose computer, for example, a processor, a controller and an arithmetic logic unit (ALU), a digital signal processor, a microcomputer, a field programmable array (FPA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct and/or configure the processing device to operate as desired, thereby transforming the processing device into a special purpose processor. Software and/or data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, and DVDs; magneto-optical media such as optical discs and floptical disks; and hardware devices that are specially configured to store and perform program instructions, such as read-only memory (ROM), random access memory (RAM), flash memory), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

While this disclosure includes specific example embodiments, it will be apparent to one of ordinary skill in the art that various alterations and modifications in form and details may be made in these example embodiments without departing from the spirit and scope of the claims and their equivalents. For example, suitable results may be achieved if the described techniques are performed in a different order, and/or if components in a described system, architecture, device, or circuit are combined in a different manner, and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. A method of providing type information and evaluation information, the method comprising:
storing and maintaining an evaluation item about an individual;
verifying data collected from at least one of a terminal of an evaluation target and a reader device installed at a predetermined place, the collected data including location and timestamp data of the evaluation target; and
creating at least one of type information and information for evaluating the target based on a predetermined correlation between the evaluation item and the collected data.

2. The method of claim 1, wherein the evaluation item includes at least one of items for evaluating a personal life, items for evaluating a group that the individual is affiliated with, and items associated with inferring personal lifestyle.

3. The method of claim 2, wherein the items for evaluating the personal life includes at least one of diligence, sincerity, teamwork, discipline, service spirit, progressive spirit, autonomy, and self-management.

4. The method of claim 1, wherein the collected data includes at least one of location data that includes a tracking information about a location and a movement of the evaluation target, temporal data associated with the location data, regional or venue information estimated based on the location data, sensor data and event schedule information used for recognizing a situation in association with the location data or the temporal data, communication data about communications transmitted to and received from another terminal or a server, and demographic data.

5. The method of claim 1, wherein the predetermined correlation includes at least one of a correlation between the evaluation item and a place to stay of the evaluation target inferred from location data of the evaluation target, a correlation between the evaluation item and a dwell time at the place to stay, a correlation between the evaluation item and places to which the evaluation target moved, a correlation between the evaluation item and a situation of the evaluation target estimated based on sensor data and event schedule information associated with the evaluation target, the place to stay, and the dwell time, and a correlation between the evaluation item and data transmitted to and received from another terminal or a server present around the terminal.

6. The method of claim 1, wherein the predetermined correlation includes at least one of a correlation between the evaluation item and a keyword detected from communication data about communications transmitted to and received from another terminal or a server and a correlation between the evaluation item and a search log using the terminal and cookie information.

7. The method of claim 1, wherein the information for evaluating the target includes at least one of scores of diligence, sincerity, teamwork, discipline, service spirit, challenge spirit, progressive spirit, autonomy, and self-management that are evaluated based on at least one of location information, temporal information, venue and regional information, situation information, text/sound/video/action information, and biometric information extracted from the collected data.

8. The method of claim 1, wherein the information for evaluating the target includes scores of the individual and a result of comparison between the individual and a predetermined role model.

9. The method of claim 8, wherein the result of comparison includes a proximity level between lifestyle information of the role model and type information of the individual or a type information comparison result at plural time points.

10. The method of claim 8, wherein lifestyle information of the role model includes health related information.

11. The method of claim 1, further comprising:
placing the evaluation information into the information assemblage of a group that includes the evaluation target; and
collecting evaluation information of other evaluation targets included in the group, and creating evaluation information about the group.

12. An apparatus for providing type information and evaluation information, the apparatus comprising:
an evaluation item manager configured to store and maintain an evaluation item about an individual;
a collected data analyzer configured to analyze data collected from at least one of a terminal of an evaluation target and a reader device installed at a predetermined place, the collected data including location and timestamp data of the evaluation target; and
an evaluation information creator configured to create at least one of type information and information for evaluating the target based on a predetermined correlation between the evaluation item and the collected data.

13. The apparatus of claim 12, wherein the collected data analyzer is configured to collect and store at least one of location data that includes a tracking information about a location and a movement of the evaluation target, temporal data associated with the location data, regional or venue information estimated based on the location data, sensor data and event schedule information used for recognizing a situation in association with the location data or the temporal data, communication data about communications transmitted to and received from another terminal or a server, and demographic data.

14. The apparatus of claim 12, wherein the evaluation information creator is configured to create the information for evaluating the target based on at least one of a correlation between the evaluation item and a place to stay of the evaluation target inferred from location data of the evaluation target, a correlation between the evaluation item and a dwell time at the place to stay, a correlation between the evaluation item and places to which the evaluation target moved, a correlation between the evaluation item and a situation of the evaluation target estimated based on sensor data and event schedule information associated with the evaluation target, the place to stay, and the dwell time, and a correlation between the evaluation item and data transmitted to and received from another terminal or a server present around the terminal.

15. The apparatus of claim 12, wherein the evaluation information creator is configured to create the information for evaluating the target based on at least one of scores of diligence, sincerity, teamwork, discipline, service spirit, challenge spirit, progressive spirit, autonomy, and self-management that are evaluated based on at least one of location information, temporal information, venue and regional information, situation information, text/sound/video/action information, and biometric information extracted from the collected data.
